(19) United States
(12) Patent Application Publication
(10) Pub. No.: US 2021/0082005 A1
(43) Pub. Date: Mar. 18, 2021

(54) SYSTEMS AND METHODS FOR PREDICTIVE AND OPPORTUNISTIC CHARITABLE GIVING

(71) Applicant: Wells Fargo Bank, N.A., San Francisco, CA (US)

(72) Inventors: Daniel David, Charlotte, NC (US); Jonathan A. Hartsell, Mooresville, NC (US); Heath Kamp, Banner Elk, NC (US); Sarah W. Phelps, Annapolis, MD (US); Philip Sprague, Matthews, NC (US); Christina Zikeli, Charlotte, NC (US)

(21) Appl. No.: 15/252,956

(22) Filed: Aug. 31, 2016

(51) Int. Cl. G06Q 30/02; G06Q 20/10; G06Q 40/02

(52) U.S. Cl. CPC G06Q 30/0279; G06Q 50/01; G06Q 40/02; G06Q 20/102

(57) ABSTRACT

Systems, methods, and apparatuses using a server system including a processor and memory having instructions stored in non-transitory machine-readable media. The server system is structured to couple to an account of a donor, receive financial history from the account, analyze a financial health of the donor based, at least in part, on the financial history, identify a topic of interest of the donor based, at least in part, on the financial history, recommend at least one of a plurality of charities to the donor based at least in part on the topic of interest of the donor, and recommend a donation amount to one of the plurality of charities based at least in part on the financial health of the donor.

### TECHNICAL FIELD

Embodiments of the present disclosure relate generally to the field of charitable donations.

### BACKGROUND

Charitable donations are typically performed when a donor chooses to donate money or other items to a chosen charity. While a donor may have particular charities or entities that they desire to make charitable donations towards, the donor is likely unaware of other charities or entities that may fit their needs or desires better. For example, one area of charitable interest for a donor may be animals and the donor may know of a particular humane society and donate to that particular society, but the donor may be unaware that a certain charity designated for the donor's animal of interest (e.g., Labrador retrievers) may exist. Without knowing a particular charity exists, the donor may not have the opportunity to donate to that charity. In this regard, conventional “giving” or charitable contributions are limited to donor's own knowledge and, therefore, fail to provide the fullest benefit to the donor and donee.

### SUMMARY

A first exemplary embodiment relates to a system. The system includes a server system including a processor and memory having instructions stored in non-transitory machine-readable media. The server system is structured to couple to an account of a donor, receive financial history from the account, analyze a financial health of the donor based, at least in part, on the financial history, identify a topic of interest of the donor based, at least in part, on the financial history, recommend at least one of a plurality of charities to the donor based at least in part on the topic of interest of the donor, and recommend a donation amount to one of the plurality of charities based at least in part on the financial health of the donor.

Another exemplary embodiment relates to a method. The method includes coupling to, by a bank account management circuit, an account of a donor, including processing transactions for the bank account, the transactions including at least one of checking transactions and credit card transactions; receiving, by a donor input evaluation circuit, a financial history from the account; analyzing, by a financial health circuit, a financial health of the donor based on the financial history; identifying, by the donor input evaluation circuit, a topic of interest of the donor based at least in part on the financial history; recommending, by a charity recommendation circuit, at least one of a plurality of charities to the donor based at least in part on the topic of interest of the donor; recommending, by the charity recommendation circuit, a donation amount to at least one of the plurality of charities based at least in part on the financial health of the donor; receiving, by the charity recommendation circuit, a selection from the donor of one of the plurality of charities; receiving, by the charity recommendation circuit, a selection from the donor of the donation amount to at least one of the plurality of charities; and facilitating, by a charity selection system, a donation process from the donor to one of the plurality of charities.

A further exemplary embodiment relates to an apparatus. The apparatus includes a donor input evaluation circuit structured to: receive a financial history of an account of a donor; and identify a topic of interest of the donor based at least in part on the transaction history data; a financial health circuit structured to analyze a financial health of the donor based on the financial history; a charity recommendation circuit structured to: recommend at least one of a plurality of charities to the donor based at least in part on the topic of interest of the donor; recommend a donation amount based at least in part on the financial health of the donor; receive a selection from the donor of one of the plurality of charities; and receive a selection from the donor of the donation amount to at least one of the plurality of charities; and facilitate a donation process from the donor to at least one of the plurality of charities.

These and other features, together with the organization and manner of operation thereof, will become apparent from the following detailed description when taken in conjunction with the accompanying drawings.

### BRIEF DESCRIPTION OF THE DRAWINGS

FIG. 1 is a schematic diagram of a charity selection system, according to an example embodiment.

FIG. 2 is a detailed schematic diagram of the charity selection system of FIG. 1, according to an example embodiment.

FIG. 3 illustrates an example process of facilitating a charitable donation from multiple donors from a joint donation team, according to an example embodiment.

FIG. 4 is a flow diagram of a method for facilitating a charitable donation based on the interests and financial health of a donor, according to an example embodiment.

FIG. 5 is a diagram of a donor user interface display generated by the charity selection system of FIG. 1, according to an example embodiment.

FIG. 6 is a diagram of a donor user interface display generated by the charity selection system of FIG. 1, according to an example embodiment.

### DETAILED DESCRIPTION

Referring to the Figures generally, various systems, methods, and apparatuses for facilitating opportunistic giving through a charity selection system are described herein. More particularly, systems and methods for facilitating donations from a donor to a charity based on a donor profile of the donor are described herein. In some embodiments, the donor may be a customer of a financial institution and may use the financial institution to facilitate one or more donations to the one or more charities, who also may be customers of the financial institution or alternatively, may be unaffiliated entities.

In one embodiment, a financial institution may analyze a donor's financial data (e.g., assets, liabilities, transaction history, etc.) to assess the donor's financial health. The financial health may include, for example, an assessment of the donor's available funds after paying all or mostly all recurring and typical liabilities per month. The financial institution may further determine personal non-financial interests of the donor based on past purchases, social media accounts, and other information relating to the activities of the donor. The financial institution then may determine areas in which the donor may be interested in donating, investing, or funding. The financial institution may present relevant donation opportunities to the donor based on the donor's financial health and personal interests.

According to various example embodiments, as described in further detail below, facilitating charitable donations based on a financial health analysis and on interests of the donor improves the ability for a financial institution to identify and recommend charitable donation opportunities that are financially viable for the donor, as well as personally relevant to the donor. Unlike conventional charitable giving, the embodiments described herein generate an analysis of a donor's interests (based on the individual's financial data, social media activity, and so on) to identify charitable donation opportunities that are personally relevant to the donor. Further, the individual's financial health may also be analyzed to provide recommended donation amounts and times so as to ensure that the donation opportunities are financially viable for the donor. Accordingly, embodiments described herein improve the ability and decrease the amount of time required for a donor to identify relevant and financially viable donation opportunities. Moreover, the embodiments described herein may provide beneficial tax implications for the donor. Further, embodiments described herein enable direct bill pay of charities by the donor and additionally enable joint donation opportunities between two or more donors who may be interested in similar charities or donation opportunities. Additionally, embodiments described herein enable more timely alerts to a donor for donation opportunities. For example, donation opportunity alerts relating to a charity can be provided to a donor while the donor is at the charity location.

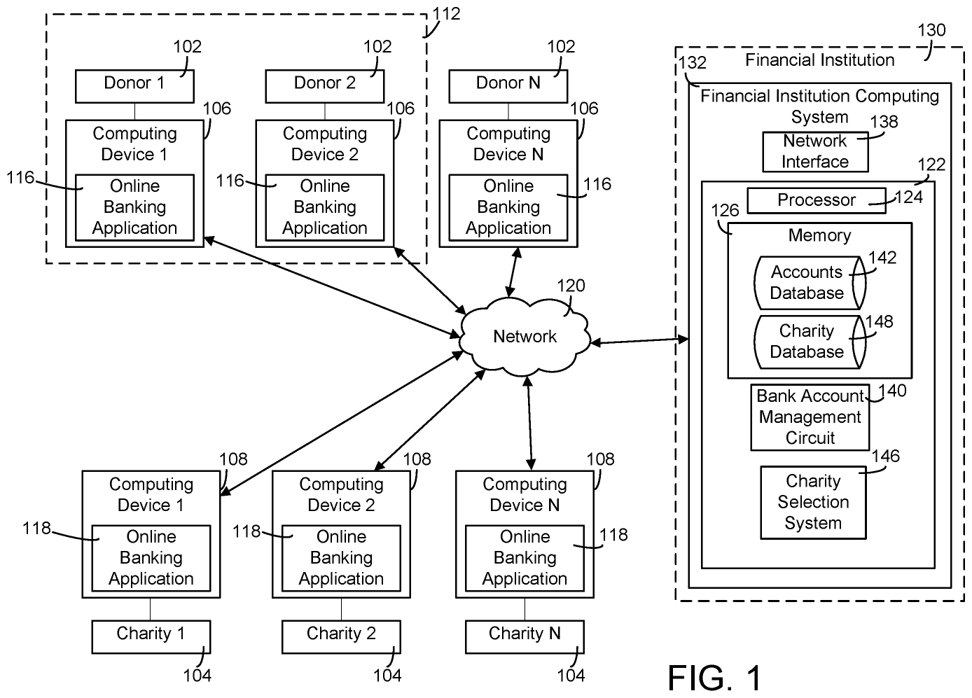

Referring now to FIG. 1, a block diagram of a system 100 is shown, according to an example embodiment. As described in further detail below, the system 100 may facilitate a charitable donation from a donor 102 to a charity 104. The system 100 may further facilitate the recommendation of charities 104 to a donor 102 and additionally, recommend a charitable donation. The system 100 may receive interests and the financial health of the donor 102 to determine charity and donation amount recommendations to the donor 102. As shown, the system 100 may include a financial institution computing system 132 associated with a financial institution 130, the financial institution computing system 132 communicably and operatively coupled to one or more computing devices 106 of one or more donors 102 and one or more computing devices 108 of one or more charities 104 over a network 120. The network 120 may provide communicable and operative coupling between the computing devices 106 of the donors 102 and the financial institution computing system 132, computing devices 108 of the charities 104, and other components disclosed and described herein to provide and facilitate the exchange of communications (e.g., data, instructions, messages, values, commands, etc.). Accordingly, the network 120 may include any network including wired (e.g., Ethernet) and/or wireless networks (e.g., 802.11X, ZigBee, Bluetooth, Internet, WiFi, etc.) In some embodiments, the network 120 may further include a proprietary banking network to provide secure or substantially secure communications.

As shown, the system 100 depicts multiple donors (e.g., donor 1, donor 2, etc.) and multiple computing devices (e.g., computing device 1, computing device 2, etc.) associated with multiple charities. This depiction is for illustrative purposes only to show an implementation environment of the systems and methods described herein. Each of these entities may have the same or similar characteristics. For the purpose of clarity, the disclosure contained herein is in reference to a single donor and a single computing device associated with a single charity.

The donor 102 may include any type of entity (e.g., a company, corporation, business, organization, an individual user, etc.) who may wish to donate to one or more charities 104. The donor 102 may have an account with the financial institution 130 and facilitate a donation to a charity 104 through the financial institution computing system 132. In other embodiments, the donor 102 may be unaffiliated or associated with the financial institution 130. Individual donations may be facilitated by a single donor 102 or by two or more donors 102 that together form a joint donation team 112 to collectively donate and/or fundraise for a charity 104 or multiple charities.

In some embodiments, various donors 102 associated with the joint donation team 112 may be distributed across multiple locations, or may be in a single location. It should be understood that the type of donor 102 donating to charities 104 as described in the present disclosure is not limiting. In various embodiments, the environment of FIG. 1 may include any number of donors 102 or joint donation teams 112.

The charity 104 may include any type of entity who desires accept donations from one or more donors 102. For example, the charity 104 may include, but is not limited to, a company, corporation, business, organization, 501(c)(3) organization, government institution, any other group, an individual, etc. It should be understood that the type of charity 104 receiving donations from the donor 102 as described in the present disclosure is not limiting.

The computing devices 106, 108 may include any type of computing device that may be used to facilitate donations from the donor 102 to the charity 104. In this regard, the computing devices 106, 108 may include any wearable and non-wearable device. Wearable devices refer to any type of device that an individual wears including, but not limited to, a watch (e.g., smart watch), glasses (e.g., eye glasses, sunglasses, smart glasses, etc.), bracelet (e.g., a smart bracelet), etc. Computing devices 106, 108 may also include any type of mobile device including, but not limited to, a phone (e.g., smart phone, etc.) and a computing device (e.g., desktop computer, laptop computer, personal digital assistant, etc.).

Each donor 102 may access an application of the financial institution 130 via a computing device 106 and more particularly an online banking application 116 of the computing device 106. The online banking application 116 may facilitate receiving and displaying screens including account information, transaction instructions, and so on. Thus, the online banking application 116 may facilitate management of donor accounts and transactions. In some embodiments, the online banking application 116 may be incorporated with an existing application in use by the financial institution 130. In other embodiments, the online banking application 116 may be a separate application. The online banking application 116 may be downloaded by the computing device 106 prior to its usage, may be hard coded into the memory of the computing device 106, or may be a web-based interface application such that the computing device 106 may provide a web browser (or other client interface) to the application, which may be executed and maintained remotely. In the latter instance, the user may have to log onto or access the web-based interface before usage of the applications. Further, and in this regard, the online banking application 116 may be supported by a separate computing system including one or more servers, processors, network interface circuits, etc. that transmit the applications for use to the computing device 106. In certain embodiments, the online banking application 116 may include an application programming interface (API) and/or a software development kit (SDK) that facilitate the integration of other applications with the online banking application 116. In another embodiment, the online financial application 116 could be provided as a single application.

Still referring to FIG. 1, the system 100 includes the financial institution computing system 132. The financial institution computing system 132 may include a network interface 138, which may be used to establish connections with other components of the system 100 by way of network 120. The network interface 138 may include program logic that facilitates connection of the financial institution computing system 132 to the network 120. The network interface 138 may support communication between the financial institution computing system 132 and other systems, such as the computing devices 106, 108. For example, the network interface 138 may include a cellular modem, a Bluetooth transceiver, a Bluetooth beacon, a radio-frequency identification (RFID) transceiver, and a near-field communication (NFC) transmitter. In some arrangements, the network interface 138 may include the hardware and machine-readable media sufficient to support communication over multiple channels of data communication. Further, the network interface 138 may include cryptography capabilities to establish a secure or relatively secure communication session with the financial institution computing system 132 and computing devices 106, 108. In this regard, financial data (or other types of data) may be encrypted and transmitted to prevent or substantially prevent the threat of hacking.

The financial institution computing system 132 may further include a bank account management circuit 140. The bank account management circuit 140 may be structured to manage a bank account for an account holder of the financial institution 130. The account holder may be a donor 102 or a charity 104. The account holder may have any type of account with the financial institution 130 (e.g., a general account for a plurality of banking-related functions, an account solely for receiving charitable donations, etc.). For example, the account may be for a company or other large entity and the bank account management circuit 140 can be used for various large-scale banking needs, or the account may be for an individual and the bank account management circuit 140 may be used for personal banking needs.

The bank account management circuit 140 may be configured to provide various banking-related features to the account holder (e.g., a donor 102) that may or may not relate to the donation activities of the account holder. As an example, the bank account management circuit 140 may process transactions such as deposits and credits stemming from, for example, credit card transactions, mobile wallet purchases, direct deposits, and the like. As another example, the bank account management circuit 140 may process various payments to and from an account holder relating to a number of liabilities (e.g., mortgages, educational loans, home equity loans, etc.) and assets (e.g., investments, a demand deposit account, etc.).

The financial institution computing system 132 may further include an accounts database 142. The accounts database 142 may hold, store, categorize, and otherwise serve as a repository for accounts held by the financial institution 130. The accounts database 142 may be structured to selectively provide access to information relating to an account at the financial institution. In this regard, as discussed further herein, the accounts database 142 may be communicably and operatively coupled to the charity selection system 146 to provide access to such information, such that the charity selection system 146 may recommend and facilitate donations from one or more donors 102 to one or more charities 104 based on that information.

In some embodiments, more than one financial institution 130 with an associated financial institution computing system 132 may be communicably coupled to the components of FIG. 1 over the network 120 to accommodate several accounts held by a donor 102 or charity 104 by two or more financial institutions. In some embodiments, the charity 104 may not have an account with the financial institution 130, and the financial institution may facilitate a donation to the charity 104 from the donor 102 without the charity 104 having an account at the financial institution 130.

In some embodiments, the account information stored by the accounts database 142 may include donor 102 or charity 104 activity with the financial institution 130. For example, the account information may include previous donation information associated with a donor 102 or charity 104 (e.g., previous donations paid by the donor to a particular charity, etc.).

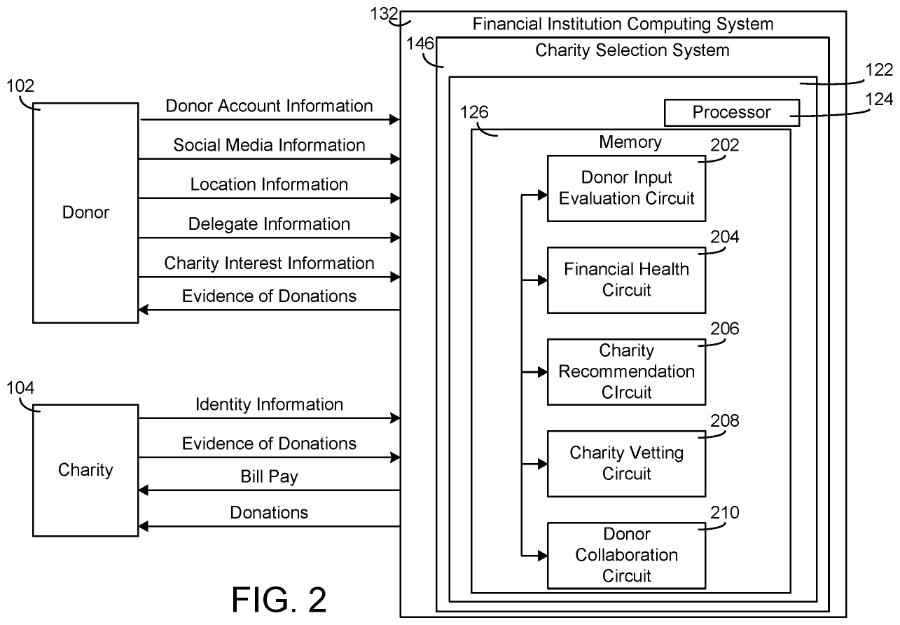

The account information may further include the financial health of the donor 102. For example, as described below, a charity selection circuit 146 may be configured to determine the donor's capability to donate based on the donor's available funds (e.g., based on an account balance in one or more of donor's accounts held by the financial institution 130), the donor's monthly bills, the donor's desired donation percentage, and so on. The account information may further include one or more interests of the donor 102, indicating a possible area of interest for a future donation. Such account information is described in greater detail with reference to FIG. 2. In addition to storing account information related to charitable donations for donors 102 and charities 104, the accounts database 142 may further store account information for non-donation accounts of the donors 102 and charities 104 (i.e., storing account information for any type of banking activity associated with the financial institution 130).

The financial institution computing system 132 may further include a charity database 148. The charity database 148 may hold, store, categorize, and otherwise serve as a repository for charities 104. The charity database 148 may be structured to selectively provide access to information relating to one or more charities 104 to which one or more donors 102 may donate. In this regard, the charity database 148 may be communicably and operatively coupled to the charity selection system 146 to provide access to such information, such that the charity selection system 146 may validate a charity as a legitimate charitable entity or organization. Such processes are described more fully herein below.

The financial institution computing system 132 may include a charity selection system 146 for managing a donation between one or more donors 102 and charities 104. The charity selection system 146 may be structured to provide a recommendation for charities to the donor 102 based on at least one of inputs from the donor 102 and financial health of the donor 102. The charity selection system 146 may further receive a selection of a donation amount and charity from the donor 102 and facilitate the donation from the donor 102 to the charity 104 based on the selection. The charity selection system 146 may be configured to use donor account information stored in the accounts database 142 (or information received directly from the donor) to determine which donation options and/or recommendations to provide to a particular donor 102, according to an exemplary embodiment.

Referring now to FIG. 2, a diagram of the charity selection system 146 and part of the financial institution computing system 132 is shown according to an example embodiment. As shown, the financial institution computing system 132 may include a processing circuit 122, which may further include a processor 124 and a memory 126. The processor 122 may be implemented as a general-purpose processor, an application specific integrated circuit (ASIC), one or more field programmable gate arrays (FPGAs), a digital signal processor (DSP), a group of processing components that may be distributed over various geographic locations or housed in a single location, or other suitable electronic processing components. The one or more memory devices 126 (e.g., RAM, NVRAM, ROM, Flash Memory, hard disk storage, etc.) may store data and/or computer code for facilitating the various processes described herein. Moreover, the one or more memory devices 126 may be or include tangible, non-transient volatile memory or non-volatile memory. Accordingly, the one or more memory devices 126 may include database components, object code components, script components, or any other type of information structure for supporting the various activities and information structures described herein.

The charity selection system 146 may be embodied with the financial institution computing system 132. Accordingly, the charity selection system 146 may be embodied or at least partly embodied in the memory 126, where at least some operations may be executable from the processing circuit 122. As described above, the charity selection system 146 may facilitate a donation from a donor 102 to one or more charities 104. The charity selection system 146 may determine when and which charities to present to the donor 102 for donations based on one or more donor inputs and financial health information regarding the donor. The charity selection system 146 may additionally match the donor 102 with other similarly interested donors to create joint donation teams 112. Beneficially, such activities, operations, and processes may facilitate donations that better match the donor's interests, donations that are within a budget of the donor (e.g., based on the financial health of the donor), and donations that are relatively optimal times for the user (e.g., at or near a tax filing deadline, etc.).

The charity selection system 146 is shown to include a donor input evaluation circuit 202, a financial health circuit 204, a charity recommendation circuit 206, a charity vetting circuit 208, and a donor collaboration circuit 210, with all such circuits communicably coupled to each other. Other embodiments may include more or less circuits without departing from the spirit and scope of the present disclosure. Further, some embodiments may combine the activities of one circuit with another circuit to form a single circuit. Therefore, those of ordinary skill in the art will appreciate that the present arrangement is not meant to be limiting.

The donor input evaluation circuit 202 may be structured to receive non-financial institution data from the donor 102. The donor input evaluation circuit 202 may additionally be structured to use the non-financial institution data to determine one or more interests of the donor 102. As one example, the non-financial data may include charity interest information from the donor 102. The charity interest information may include an area of charitable interest of the donor 102. For example, a donor 102 may provide that an area of charitable interest is charities that provide care for dogs. As another example, the donor 102 may provide that an area of charitable interest is children's research hospitals. Thus, the “area of charitable interest” provided may be highly variable and generally refers to a category of charitable interest (e.g., forest preservation, ocean preservation, local school board funding, etc.). In some embodiments, the charity interest information may be configured as tags that the donor may select from a list of interest tags provided by the financial institution. “Tags” may include interests that the donor may select to add to the list of charitable interests received by the donor input evaluation circuit 202. The tags may be configured where donors can simply click on the name of the tag to input that interest into the system.

As another example of non-financial institution data, the donor input evaluation circuit 202 may be configured to receive social media information from the donor 102 (e.g., Twitter account information, Facebook account information, etc.) and use the social media information to determine personal interests. In one embodiment, the donor input evaluation circuit 202 may be communicably coupled to a social network to retrieve info relating to the donor 102. To achieve this, the donor 102 may provide login information to the social network to the donor input evaluation circuit 202. For example, if the donor 102 has several social media posts relating to an event, the donor input evaluation circuit 202 may determine a donor's interest in the event. As another example, if the donor 102 leaves a comment or “likes” a particular social media page, the donor input evaluation circuit 202 may determine an interest relating to the subject of the social media page.

As another example, donors may be associated with an organization (e.g., church) on social media. The organization may routinely donate and fundraise for a specific charity (e.g., homeless shelter) such that the charity seeks donations and volunteer help through the organization on a regular basis. The charity can send alerts directly to donors associated with the organization through social media to indicate a need for donations or other charitable help.

In a non-routine and unconventional manner, the donor 102 may provide log-in information for one or more social media websites. Responsive to such reception, the donor input evaluation circuit 202 may generate a web browser and travel to the social media website and login. Upon login, the donor input evaluation circuit 202 may utilize screen scrape technology or keyword search mechanisms to identify text indicative of a donor's interests or hobbies. For example, the donor input evaluation circuit 202 may identify areas on the website that say “interests,” “hobbies,” etc. In some embodiments, the donor input evaluation circuit 202 may further be structured to analyze graphical images indicative of the donor's interests on the social media website. In further embodiments, an application program interface (API) can be used to allow access to the donor's social media data through back-end channels. For example, a social media site (e.g., Facebook, Twitter, etc.) can provide an API to allow access to social media data of the donor 102.

Upon retrieval of such information, the donor input evaluation circuit 202 may utilize one or more formulas, processes, algorithms, and the like to identify interests of the donor 102. For example and in one embodiment, every identified “like” on a social media website may be classified as an area of interest for the donor 102. In another example embodiment, a weighing process may be used to identify the highest interests of the donor 102 (e.g., if “basketball” is mentioned ten times and “dogs” are mentioned once, the circuit may weight “basketball” higher than “dogs”). In some instances, a minimum number of mentions of a potential area of interest may be required before the donor input evaluation circuit 202 identifies it as an area of interest.

As yet another example of non-financial institution data, the donor input evaluation circuit 202 may receive location data of the donor 102. In one embodiment, the donor input evaluation circuit 202 may be communicably coupled to the computing device 106 of the donor 102, including to the donor's mobile device. Using information received from the mobile device's location positioning sensor (e.g., Global Positioning System (GPS), etc.), the donor input evaluation circuit 202 may determine the location of the donor 102. In another embodiment, the donor input evaluation circuit 202 may receive a donor input regarding a location where the donor 102 is located. The location data may be used to provide the donor 102 with charitable donation opportunities to charities 104 that are local to the donor 102, or to causes and events that are local to the donor 102. This may allow the donor 102 to donate to causes and/or charities 104 that are local to the donor 102 and therefore, may be of greater interest. For example, if the donor 102 visits or is located near a specific animal shelter, that specific animal shelter may be provided to the donor 102 as a local charitable donation opportunity. Further, the donor 102 can be provided with an alert on the computing device 106 of an opportunity to donate while at the animal shelter. Location data may be used in connection with any other donor information to determine recommendations for charitable donation opportunities.

As a further example of non-financial institution data, the donor input evaluation circuit 202 may receive a charitable profile of the donor 102. The charitable profile of the donor 102 may include any previous history of past donation activities of the donor 102, including that the donor 102 has made donations to a particular charity, the timing of the donations, and the amount of the donations. In some embodiments, previous donation information may be used by the donor input evaluation circuit 202 to determine an interest of the donor 102. For example, if the donor 102 has previously donated to a charity 104 for a particular cause, the donor 102 may consider donating to a similar cause in the future. The donor input evaluation circuit 202 may analyze previous donation information to determine one or more areas of interest that the donor 102 is more likely to donate to in the future. The donor input evaluation circuit 202 may additionally analyze trends and/or past donations of other donors that have donated to the same charity 104 as the donor 102. For example, another donor has donated to a particular charity that the donor 102 has donated to, along with various other charities to which the donor 102 has not donated. The donor input evaluation circuit 202 may analyze the donations of other donors for the charity recommendation circuit 206 to present the donor 102 with additional charities as opportunities for donation.

As another example of non-financial institution data, the donor input evaluation circuit 202 may receive a behavioral analysis of the donor 102. The behavioral analysis may include a purchase history or other such financial data of the donor 102 (such information may also be retrieved from a bank account management circuit 140). The behavioral analysis may be used to determine potential areas of charitable interest of the donor 102. The purchase history may relate to a plurality of financial transactions in which the donor 102 has participated, such as a plurality of purchases made by the donor. The purchase history may indicate an area of interest of the donor 102 as the donor 102 may have been shown to spend money on the area of interest. The area of interest may then be used to identify charitable donation opportunities that are related to the area of interest of the donor 102. As one example, the donor 102 may often make purchases at a particular store or particular type of store (e.g., a particular restaurant or type of restaurant). For instance, completing transactions at a sporting goods store and buying tickets for a sporting event may allow the donor input evaluation circuit 202 to determine that the donor 102 may be interested in donating to a sports-related charity (e.g., a youth sports charity). The donor input evaluation circuit 202 may be configured to track purchase history to determine if the donor 102 has any spending trends that can be identified, and may use any threshold for determining an area of interest of the donor (e.g., the donor 102 visiting a store a minimum number of times in a month or a year, the donor 102 completing a minimum number of transactions in a month or year, etc.).

As another example, other personal information (e.g., gender, ethnicity, education background, age, etc.) may be used to determine an area of interest of the donor 102. In one embodiment, the donor 102 may input personal information into the donor input evaluation circuit 202. In another embodiment, the donor 102 may allow access to a social profile. In yet another embodiment, the information may be received through an online application associated with a financial institution. As an example of personal information, a college or university the donor 102 attended may be identified, which may be used to suggest charitable donation opportunities associated with that particular college or university. As another example, gender, ethnicity, or age may be used to identify charities and/or donation opportunities that are tailored to be advantageous to a particular group of people.

As yet another example, one or more organizations or other groups the donor 102 belongs to may be used to determine an area of interest of the donor 102. In one embodiment, the donor 102 may input one or more organizational affiliations into the donor input evaluation circuit 202. In another embodiment, the donor 102 may allow access to a social profile containing such information. In yet another embodiment, the information may be received through an online application associated with the financial institution. As an example, if the donor 102 is religious, charities and/or donation opportunities to charities relating to a particular religion may be identified as possibly relevant to the donor 102. As another example, if the donor 102 belongs to a group participating in a particular hobby, the donor 102 may be presented with donation opportunities relating to the hobby. As a further example, if an individual is injured in a car accident, alerts can be sent to direct connections and connections of the direct connections (e.g., second-order connections, friends of friends) to pay the hospital bills of that individual. These alerts can be sent via social media sites or directly to the computing device 106 of the donor 102. Alerting various donors 102 of potential donation opportunities results in more timely and efficient donations.

Further, as part of the charity interest information received by the donor input evaluation circuit 202, the donor 102 may provide a point in time during which the donor 102 may desire to donate. As an example, the donor 102 may provide that during a certain season of the year the donor is likely to make a donation. For instance, the donor 102 may designate the fall season as the time during which the donor 102 desires to make donations. As another example, the donor 102 may provide a certain date for making one or all of the donations the donor 102 intends to make during the current year, month, or week. As such, the date for making donations may coincide with when the donor 102 gets paid (e.g., bimonthly). As yet another example, the donor 102 may provide that during a certain time period, the donor 102 will not make any donations and as such, the charity selection system 146 can withhold any charity recommendations during that time. As another example, the donor 102 may indicate that the donor 102 will make donations during a time of need (e.g., immediately after a natural disaster).

In one embodiment, the non-financial institution data may be provided to the charity selection system 146 manually by the donor 102. In another embodiment, the non-financial institution data may be provided to the charity selection system 146 automatically. For example, the social media information may be provided to the charity selection system 146 automatically based on the social media activity of the donor 102. This data may be shared by the donor 102 via the donor's approval. In various embodiments, the donor 102 may choose which personal information to provide to the charity selection system 146. As an additional example, the donor 102 may provide a “favorites” list of charities to the charity selection system 146 to which the donor 102 is interested in donating.

The charity selection system 146 further includes a financial health circuit 204. The financial health circuit 204 may be configured to analyze the financial health of the donor 102. As used herein, the phrase “financial health” refers to an indication regarding the financial state of the donor. In this regard, financial state refers to an overall or global view of the financial affairs of the donor (e.g., assets, liabilities, etc.). The financial health may reference the financial ability of the donor 102 to make certain amounts of charitable donations. In some embodiments, the financial health of the donor 102 may be determined based on the financial history of the donor, account information of the donor, etc. For example, referring also to bank account management circuit 140, a transaction history, a bank account (e.g., a current balance, a trend, etc.), and other information for the donor 102 may be analyzed. Transactions executed by the donor 102 may be analyzed to determine a financial obligation of the donor (e.g., a weekly, monthly, or yearly payment for one or more services, one or more loans for which the donor is responsible for, etc.). Historical account balances and variability in expenses of the donor 102 may be analyzed to determine the funds the donor 102 typically has on hand. Additionally, income (e.g., direct deposits) may be analyzed to determine the ability of the donor 102 to maintain or grow his or her assets. All such information may be used to determine a “cushion”, i.e., an excess amount of money that the donor 102 may be able to use for charitable donation opportunities.

The financial health of the donor 102 as determined, predicted, or otherwise generated by the financial health circuit 204 may include a donation capacity of the donor (e.g., a maximum amount that the donor is capable of donating to a charity). The donation capacity may indicate a total amount or a monthly or weekly amount (e.g., an amount per month or week that the donor is capable of donating), and may further include various parameters such as when the donor is capable of making the payment (e.g., first of month, last of month, more or less in a given time period, etc.).

The charity recommendation circuit 206 may be structured to provide at least one charity recommendation to the donor 102. In one embodiment, the charity recommendation may be provided via an online application as described with reference to FIG. 1. The charity recommendation circuit 206 may communicate with the donor input evaluation circuit 202 and the financial health circuit 204 to determine which charities and which charitable donation amounts to recommend to the donor 102. The one or more recommended charities and/or amounts may be based on information received from these other circuits. For example, based on the charitable interests of the donor 102 (as determined by the donor input evaluation circuit 202), the donor 102 may be provided with recommended charities 104 that the donor 102 may be interested in and based on the financial health of the donor 102 (as determined by the financial health circuit 204), the donor 102 may be provided with recommended charitable donation amounts. The charity recommendation may additionally indicate that the financial institution 130 will match the donation of the donor 102 to particular charities. For example, if the financial institution 130 has determined that certain charitable donations will be matched, the financial institution 130 can include that information with the charity recommendation to the donor 102. The financial institution 130 may determine matching opportunities by determining that particular charities are donated to more often if matching is offered to donors. In some embodiments, matching opportunities can be facilitated by the charity vetting circuit 208, described further herein.

As described above, the charity recommendations may be provided to the donor 102 via an online application. The information provided with the charity recommendations may include the recommended charity, the recommended donation amount, and other detailed information that allows the donor 102 to make an informed decision. In some embodiments, the donor 102 may be presented with information about how the recommended charities were selected. For example, if a charity was provided because of a donor 102 interest identified by the donor input evaluation circuit 202, the donor 102 may be informed of such a selection.

The charity selection system 146 further includes a charity vetting circuit 208. The charity vetting circuit 208 may be configured to validate the charity 104 (e.g., to determine that the charity is a legitimate entity requesting aid for charitable purposes). In some embodiments, a charity 104 may be a customer of the financial institution 130, and information regarding the identity of the charity 104 may be included with the account information for the charity 104. In other embodiments, a charity 104 may not be a customer of the financial institution 130. The financial institution 130 may still be capable of validating that charity and facilitating a donation to the charity 104 from a donor 102.

In some embodiments, the charity vetting circuit 208 may determine a rating, ranking, or other metric that can be used to determine if the charity is a legitimate entity. As an example, the charity vetting circuit 208 may receive identity information from the charity 104 including, but not limited to, a tax identification number, annual financial reports, and articles of incorporation, and use that information to determine that a charity is legitimate.

In some embodiments, the charity vetting circuit 208 may additionally receive evidence of donations from the charity 104. The evidence of donations may be used by the donor 102 for tax deduction purposes. The evidence of donations may include, but is not limited to, a receipt showing the amount of the donation and the name of the charity. In some embodiments, the evidence of donations may be sent to the donor 102 from the charity selection system 146. In other embodiments, the evidence of donations may be sent directly to a delegate that the donor 102 may designate. The delegate may include, but is not limited to, a tax preparer, a tax attorney, and a financial advisor of the donor 102. Accordingly, in operation, the charity vetting circuit 208 may cause generation of an email including the evidence of donations (e.g., as an attachment, as a clickable link, etc.) that may be transmitted to the delegate. In another instance, the charity vetting circuit 208 may cause generation of a mail message or facsimile having the evidence of the donations that may be subsequently transmitted to the delegate. The delegate may then use the evidence of donations to prepare the appropriate tax documents or other desired documents for the donor 102.

The charity selection system 146 further includes a donor collaboration circuit 210. The donor collaboration circuit 210 may be structured to match up donors 102 that are interested in donating to the same or similar charities 104, such that they can form a joint donation team 112 as described in FIG. 1 to collectively donate and/or fundraise for a charity 104. The donor collaboration circuit 210 may be configured to provide a suggestion for a donation amount to each donor 102 of the joint donation team 112. For example, the donor collaboration circuit 210 may identify (e.g., recommend) a specific amount based on the financial health (as determined by the financial health circuit 204) of each donor 102. In some embodiments, the suggested donation amounts may be displayed to each donor 102 of the joint donation team 112. In other embodiments, the suggested donation amounts may be private to each donor 102 of the joint donation team 112. Further, in some embodiments, the total donation amounts may be displayed to individual donors 102 of the joint donation team 112 such that the donors 102 may have access to information regarding when or if a set charitable donation goal has been met. In some embodiments, the donor collaboration circuit 210 may be configured to notify all donors 102 within a joint donation team 112 when a charity goal is met, projections on when a goal may be met in the future, and may provide other such management-related features when more than one donor 102 is involved in donating to a charity 104.

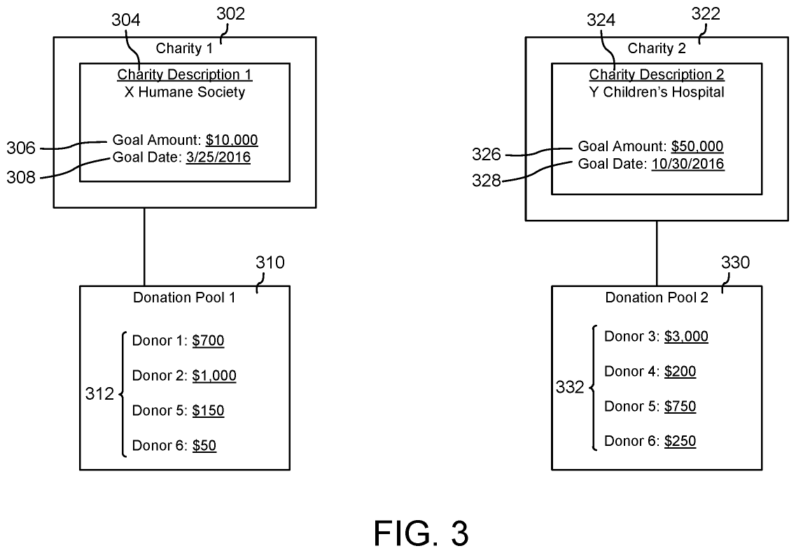

Referring also to FIG. 3, a donation facilitated to a charity from a plurality of donors is illustrated in greater detail. A first charity 302 may be recommended by the charity recommendation circuit 206 to a donation pool 310, including a plurality of donors 312. Information about the first charity 302 may include information, such as a title or other description of the charity (e.g., “X Humane Society”). This description 304 may be used by the charity selection system 146 to match potential donors 102 that may be interested in donating to the same or similar charities. For example, using the description, the donor collaboration circuit 210 may match donors who have shown an interest in donating to humane societies to each other, and create a donation pool 310 of potential interested donors 312.

A subset of the donors in the donation pool 310 may choose to donate to the first charity 302. As shown in FIG. 3, four different donors 312 are shown to form a group to at least one of donate and organize campaign efforts for the first charity 304. Each donor 312 is shown to donate a certain amount to the charity. Each donor 312 may specify how much he or she is willing to donate, and the donor collaboration circuit 210 may be configured to manage a process of allowing multiple donors to donate to a single charity and further, inform each of the donors 312 of each other such that the donors 312 may decide to collaborate with one another and possibly raise more money for the charity or provide fundraising and awareness for the charity in other ways.

A second charity 322 with a second donation pool 330 is illustrated in FIG. 3. Each charity provided may result in a different donation pool 330 created, including different donors who may have different interests and financial capabilities. A plurality of donors 332 are shown to agree to donate a certain amount to the second charity 322. In some embodiments, a single donor (e.g., “Donor 5” and “Donor 6”) may donate to multiple charities simultaneously. Donors may be capable of donating to more than one charity, and may be placed in more than one donation pool for a particular charity or type of charity.

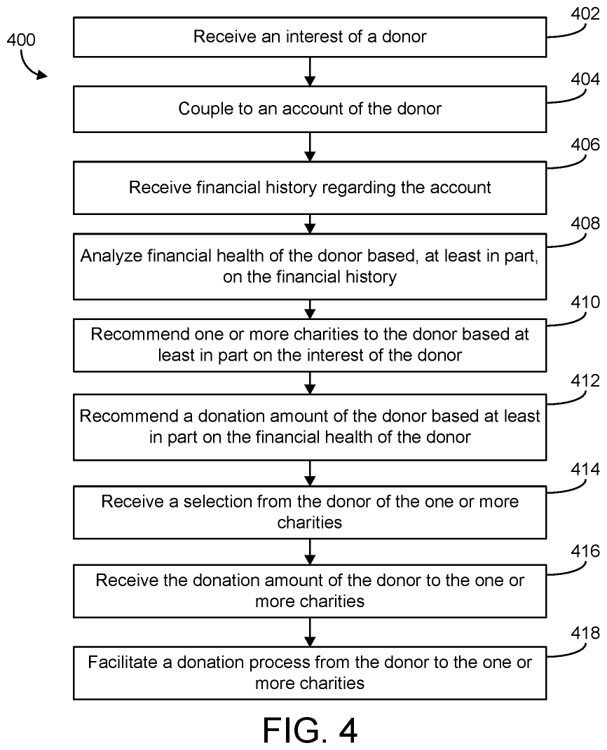

Referring now to FIG. 4, a flow chart of a process 400 for facilitating opportunistic donations from one or more donors to charities is shown, according to an example embodiment. The process 400 may be implemented with the charity selection system 146 of FIGS. 1-2, such that reference may be made to one or more components of FIGS. 1-2 in explaining process 400.

At process 402, an interest from a donor is received. Process 402 may be performed by the donor input evaluation circuit 202. As mentioned above, each donor may designate interests that the donor may have. Each donor's history of spending may additionally be received by the donor input evaluation circuit 202 as a possible interest of the donor. These interests may be used by the financial institution 130 to determine charities 104 to which the donor 102 may be interested in donating. For example, the donor input evaluation circuit 202 may receive possible interests of the donor 102 through recent spending habits of the donor at a particular pet store that sells dog food and training gear. This may be received as an interest in dogs.

In some embodiments, process 402 includes retrieving information from a social media account of the donor with the bank account of the donor. Social media activity data may then be received from the social media account and used to determine a topic of interest of the donor. If the topic of interests closely matches one or more charities, those charities may then be provided to the donor at process 410.

At process 404, an account of the donor is coupled. Process 404 may be performed by the bank account management circuit 140. As mentioned above, coupling to the account may generally include communicable and operative coupling for, e.g., processing transactions for the donor such as checking transactions and credit card transactions. Coupling to the account, the bank account management circuit 140 may further process various payments to and from the account holder relating to a number of liabilities (e.g., loans, bills, etc.) and assets (e.g., investments). The bank account management circuit 140 may additionally track financial history from the account of the donor as mentioned in process 406.

At process 406, financial history from the account of the donor is received. Process 406 may be performed by the bank account management circuit 140. As mentioned above, the financial history received by the charity selection system 146 may be used to recommend and facilitate donations from one or more donors 102 to one or more charities 104 based on that information.

At process 408, a financial health of the donor is analyzed. Process 408 may be performed by the financial health circuit 404. Analyzing the financial health of the donor may include using the financial history. Analyzing the financial health may generally include, for example, determining a financial obligation of the donor during a set period of time (e.g., week, month, year), and analyzing historical account balances and variability in expenses of the donor to determine the funds the donor typically has on hand.

At process 410, one or more charities are recommended to the donor. Process 410 may be performed by the charity recommendation circuit 206. Recommending one or more charities to the donor may include using the interests of the donor received by the donor input evaluation circuit 202. Process 410 may include determining one or more charities to recommend based on the interests of the donor. For example, one or more charities may be provided to the donor based on if that charity matches one or more of the interests of the donor, such as a humane society offered to a donor that has interests in the welfare of animals. Process 410 may include analyzing the financial history received at process 406 and determining attributes of the transactions to determine interests of the donor (e.g., if the donor purchased an item at the store, the type of store may be marked as an interest). If the interests match or closely match a charity, the recommended charity may then be provided to the donor. This may allow the donor to view charities that may be related to the interests of the donor.

At process 412, a donation amount is recommended to the donor. Process 412 may be performed by the charity recommendation circuit 206. Recommending a donation amount to the donor may include using the financial health of the donor as determined by the financial health circuit 204 at process 408. Recommending a donation amount to the donor may include using the timing preferences of the donor to provide a recommended donation amount at a particular time within a certain time period (e.g., year, month, week). For example, a recommended donation amount may be based on the fact that the donor may desire to donate a certain amount (e.g., $500) during the fall season of the year. In this example, during the fall, the charity selection system 146 may recommend that the donor donate $500 to one or more charities.

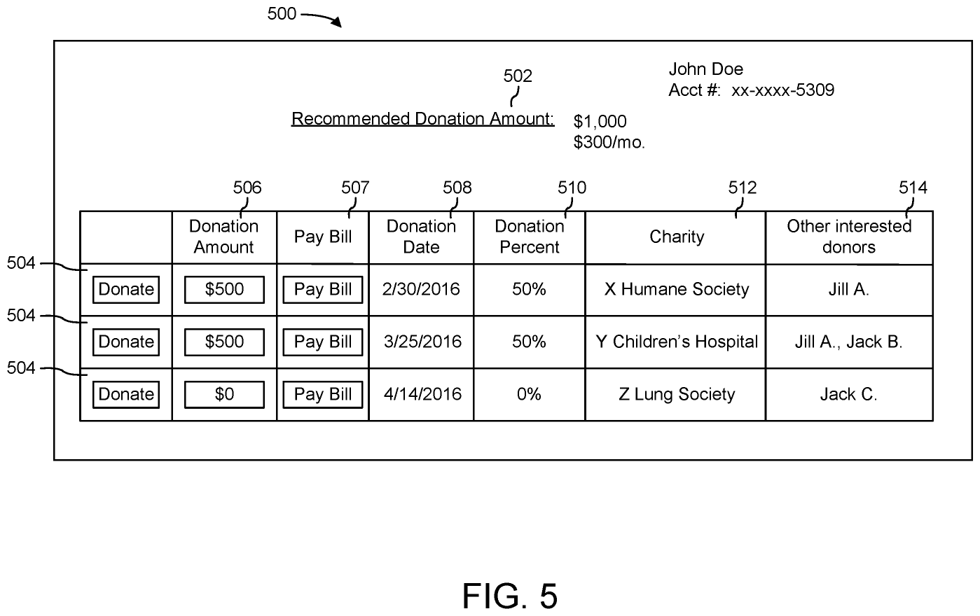

At process 414, a selection from the donor of the one or more charities is received and at process 416 a selection from the donor of the donation amount is received. Processes 414 and 416 may be performed by the charity selection system 146. As described below in regard to FIG. 5, the donor may select one or more charities and charity amounts from the user interface 500.

At process 418, a donation process from the donor to the one or more charities is facilitated. Process 418 may be performed by any and/or all of the components of the charity selection system 146. In some embodiments, the donation process may include a donation from a joint donation team 112 as described in regard to FIG. 1. The joint donation team 112 may function in the same or similar manner as a single donor 102.

Referring now to FIG. 5, an example user interface 500 showing charity and/or donation amount recommendation details for a plurality of charity recommendations to a prospective donor is shown, according to an example embodiment. The user interface 500 is an example user interface that can be presented to a donor 102 via the charity selection system 146. The user interface 500 may allow a donor 102 to select one or more recommended charities to which the donor may want to donate. In various embodiments, the recommended charities may be ranked based on a combination of any/all of the factors described above in connection with FIG. 2, and the donor may be provided with a ranked listing of the recommended charities 512 and recommended donation amounts based on, e.g., predicted interest of the donor in each of the recommended charities.

The user interface 500 may display a recommended donation amount 502. The recommended donation amount 502 may be a maximum amount that the donor may be recommended to donate without hurting the financial health of the donor. For example, the recommended donation amount 502 may be determined by the financial health circuit 204. The recommended donation amount 502 may be a total amount that the donor is recommended to donate (e.g., $1,000 total) or a total monthly or weekly amount (e.g., the donor is not recommended to donate more than $300 per month to a charity). The recommended donation amount 502 may be an amount that the financial health circuit 204 determines that the donor 102 may provide without compromising his or her financial health.

The user interface 500 may further display a recommended donation amount 506 for each recommended charity. The recommended donation amount 506 may be determined by the financial health circuit 204 in conjunction with the donor input evaluation circuit 202 to recommend donation amounts for each charity based on the financial health and interests of the donor. For example, the recommended donation amount may be an amount the donor is recommended to donate to each charity (e.g., $500 to X Humane Society, $500 to Y Children's Hospital and $0 to Z Lung Society). The user interface 500 may similarly provide a donation percent column 510 displaying the percentage of the recommended donation amount 502 that would be going to that particular charity if the donation amount 506 was donated. The donor may change the donation amount 506 and/or the donation percent 510 by typing in or selecting an amount from the donation amount column 506 and/or the donation percent column 510.

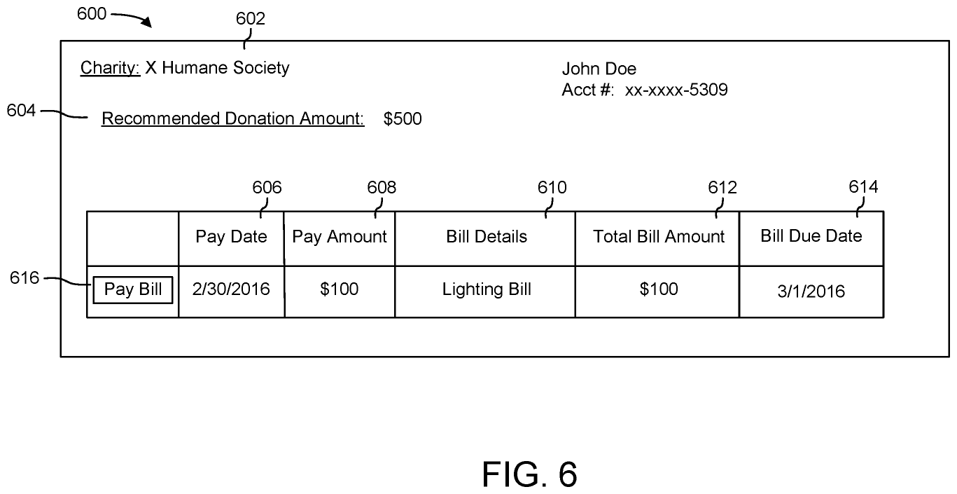

The user interface 500 may further display a pay bill option 507 for each recommended charity. In this regard, the donor may choose to directly pay a bill of the charity. The bills that are presented to the donor may be based on analysis of the financial health of the donor from the financial health circuit 204. In some embodiments, only the bills that fit within the range of the donor's financial ability as determined by the financial health circuit 204 may be displayed. If a donor selects the pay bill option 507, the donor may see the detailed bill pay user interface 600 as described further below in regard to FIG. 6.

For a given donation option 504, the user interface 500 may further provide a donation date column 508 such that the donor may select the date on which the donation should be processed. The donation date column 508 may include a suggestion from the charity recommendation circuit 206 indicating an opportune time for the donation to occur. The charity recommendation circuit 206 may use information gathered from the financial health circuit 204 and/or the donor input evaluation circuit 202 to make this determination. The donor may change the date from this suggested date by typing in or selecting a date from the donation date column 508.

Additionally, for a given donation option 504, the user interface 500 may further display an other interested donors column 514. The other interested donors column 514 may provide a list of other donors that may be interested in the same or similar charities. This list may consist of other donors placed within a donation pool 310, 330 as described in FIG. 2. The list of other interested donors 514 may provide the donor a network of other individuals and entities that may be interested in joining together to form a joint donation team 112 as shown in FIG. 1.

The user interface 500 may retain the donor on the website of the financial institution 130, while allowing the donor 102 to view donation options and recommendations. The user interface 500 may retrieve data regarding donation options from various third party websites (e.g., charity's website) and combine the retrieved data with the look and feel of the website of the financial institution 130. For example, data regarding donation opportunities at a charity may be retrieved by the system and presented to the donor 102 in the form of user interface 500, which presents the look and feel of the website of the financial institution 130.

Referring now to FIG. 6 with reference to FIG. 5, a further pop-up window of details on paying a bill of a charity is shown, according to an example embodiment. If a donor selects the pay bill button in the pay bill column 507 of FIG. 5, the user interface 500 may open a further pop-up window (e.g., bill pay user interface 600) with further detail and options of paying a bill for a specific charity. For example, if the donor selects the pay bill option for X Humane Society, the charity selection system 146 may generate a bill pay user interface 600 in the form of a pop-up window. The bill pay user interface 600 includes a charity name 602, a recommended donation amount 604, a pay date 606, a pay amount 608, bill details 610, total bill amount 612, and a bill due date 614.

As shown, the charity name 602 may display the name of the selected charity from the user interface 500. Further, the recommended donation amount 604 may include the same information displayed in FIG. 5 as the donation amount column 506 for ease of use by the donor such that the donor does not need to switch between the bill pay user interface 600 and the user interface 500 to determine a recommended donation amount for that particular charity. For example, the recommended donation amount 604 displayed in FIG. 6 is $500, which corresponds to the donation amount 506 displayed in FIG. 5 for the X Humane Society.

The pay date 606 may display the selected payment date that the donor desires the payment to be processed. The donor may change the pay date 606 by typing in a date or by selecting a date from a list provided by the charity selection system 146. In some embodiments, the pay date 606 may default to the bill due date 614.

The bill pay user interface 600 may additionally include a pay amount 608. In a similar fashion as with the pay date 606, the donor may change the pay amount 608 by typing in an amount or by selecting an amount from a list provided by the charity selection system 146. In some embodiments, the pay amount may default to the total bill amount 612. In other embodiments, the pay amount 608 may default to the recommended donation amount 604 for that particular charity. In yet another embodiment, the pay amount 608 may default to the total bill amount 612 based on if the recommended donation amount 604 exceeds the total bill amount 612, such that a donor would not pay more than what is due as the total bill amount 612. For example, in FIG. 6, the pay amount 608 is shown as defaulting to the total bill amount 612.

The bill pay user interface 600 may include bill details 610. The bill details 610 may display the details regarding the bill, which may include a type of bill, a services company to which the bill would be paid, and so on. The bill pay user interface 600 may additionally include a total bill amount 612, which may include the amount of the particular bill, and a bill due date 614, which may display the date by which the particular bill is due.

The bill pay user interface 600 may retain the donor on the website of the financial institution 130, while allowing the donor 102 to pay a bill for the charity. If a donor selects the pay bill button in the pay bill column 507 of FIG. 5, the user interface 500 may open a further pop-up window (e.g., bill pay user interface 600) with further detail and options of paying a bill for a specific charity. The bill pay user interface 600 may retrieve data regarding the charity from a charity's website and combine the retrieved data with the look and feel of the website of the financial institution 130. For example, if the donor selects the pay bill option for X Humane Society, the charity selection system 146 may generate a bill pay user interface 600 in the form of a pop-up window with information retrieved from the Humane Society's website, along with the presentation of the financial institution 130, as shown in FIG. 6.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A system comprising:
a server system including a processor and a memory having instructions stored in non-transitory machine-readable media, the instructions executable by the processor to:
couple to a financial account of a donor;
receive financial history from the account;
analyze a financial health of the donor based, at least in part, on the financial history;
access, via an application program interface of a social media platform and using log-in information provided by the donor, a social media account of the donor associated with the social media platform, wherein the social media platform allows the donor to follow social media accounts associated with one or more other users of the social media platform;
identify one or more social media accounts followed by the social media account of the donor on the social media platform;
correlate a subject of the one or more social media accounts followed by the donor with one or more charities and with a topic of interest of the donor, wherein the one or more social media accounts are separate and distinct from a social media account of one of the charities, the one or more charities recommended based at least in part on the topic of interest of the donor;
identify text indicative of the topic of interest of the donor utilizing keyword search mechanisms on the social media data from the social media account of the donor;
generate a list of the one or more charities and, for each charity in the list, a recommended donation amount based at least in part on the financial health of the donor;
present, in a user interface of a website served to the personal computing device or via an application running on the personal computing device, the list of the one or more charities and the recommended donation amount for each charity in the list;
retrieve, from one or more third party websites, data regarding donation opportunities for the one or more charities;
receive a global positioning system (GPS) coordinate from a location positioning sensor of the personal computing device of the donor;
determine, based on the GPS coordinate of the personal computing device, that the personal computing device is located within a predetermined distance from a charity in the list;
in response to determining from the GPS coordinate of the personal computing device that the personal computing device is within the predetermined distance from the charity in the list, provide, via the user interface, an alert of an opportunity to make a donation; and
generate, using the data from the one or more third party websites, a user selectable option displayable via the user interface that allows the donor to make the donation to the charity in the list presented via the user interface;
wherein a selection of the user selectable option provided by the user interface allows the donor to initiate the donation to the charity in the list in an amount equal to the recommended donation amount, or in an amount indicated by the donor via a user input field provided by the user interface.

2. (canceled)

3. (canceled)

4. (canceled)

5. (canceled)

6. The system of claim 1, wherein the donation amount recommended to the donor is within a donation capacity of the donor.

7. The system of claim 1, wherein the topic of interest of the donor is further based in part on an interest tag obtained from the social media account of the donor associated with the social media platform.

8. The system of claim 24, wherein at least one of the user selectable options includes an option of paying a bill of a selected one of the one or more charities recommended to the donor; and
wherein the server system is further configured to display, by the application and on the personal computing device of the donor, a bill pay user interface in response to the donor selecting the option of paying a bill of a charity.

9. (canceled)

10. A method comprising:
coupling to, by a bank account management circuit, a financial account of a donor, including processing transactions for the account, the transactions including at least one of checking transactions and credit card transactions;
receiving, by a donor input evaluation circuit, financial history from the account;
analyzing, by a financial health circuit, a financial health of the donor based on the financial history;
accessing, via an application program interface of a social media platform and using log-in information provided by the donor, a social media account of the donor associated with the social media platform;
identifying one or more social media accounts followed by the social media account of the donor on the social media platform;
correlating a subject of the one or more social media accounts followed by the donor with one or more charities and with a topic of interest of the donor, wherein the one or more social media accounts are separate and distinct from a social media account of one of the charities;
utilizing screen scrape technology to obtain, from the social media account of the donor associated with the social media platform, at least one of comments posted by the donor and content tagged by the donor;
identifying text indicative of the topic of interest of the donor utilizing keyword search mechanisms on the social media data from the social media account of the donor, wherein identifying, by the donor input evaluation circuit, the topic of interest of the donor is based in part on a detection of a predetermined minimum number of occurrences of one or more keywords in at least one of the comments posted by the donor, content tagged by the donor, and the subject of the one or more social media accounts on the social media platform, the one or more charities recommended based at least in part on the topic of interest of the donor;
generating a list of the one or more charities to recommend to the donor and, for each charity in the list, a recommended donation amount based at least in part on the financial health of the donor;
presenting, in a user interface of a web site served to the personal computing device or via an application running on the personal computing device, the list of the one or more charities and the recommended donation amount for each charity in the list;
receiving a global positioning system (GPS) coordinate from a location positioning sensor of the personal computing device of the donor;
determining, based on the GPS coordinate of the personal computing device, that the personal computing device is located within a predetermined distance from a charity in the list;
in response to determining from the GPS coordinate of the personal computing device that the personal computing device is within the predetermined distance from the charity in the list, providing, via the user interface, an alert of an opportunity to make a donation;
generating, within the user interface, a user selectable option to make the donation to the charity in the list recommended via the user interface;
receiving, a selection from the donor of the user selectable option;
receiving, by the charity recommendation circuit, a selection from the donor of a donation amount to the charity in the list; and
initiating, in response to receiving the selection from the donor and by a charity selection system, a donation process from the donor to the charity associated with the user selectable option.

11. (canceled)

12. The method of claim 10, further comprising matching, by a donor collaboration circuit, the donor to other prospective donors, wherein the donor and the other prospective donors have at least one topic of interest in common.

13. (canceled)

14. The method of claim 27, wherein at least one user selectable option includes a bill pay option for paying a bill of one of the one or more charities recommended to the donor, the charity recommendation circuit displaying, by the application and on the personal computing device of the donor, a bill pay user interface in response to the selection by the donor of the bill pay option.

15. (canceled)

16. (canceled)

17. An apparatus, comprising:
a donor input evaluation circuit structured to:
couple to a financial account of a donor;
receive a financial history from the account; and
provide, via an application accessible on a personal computing device of the donor, the donor with access to the financial history from the account;
a financial health circuit structured to analyze a financial health of the donor based on the financial history; and
a charity recommendation circuit structured to:
access, via an application program interface of a social media platform and using log-in information provided by the donor, a social media account of the donor associated with the social media platform, wherein the social media platform allows the donor to follow social media accounts associated with one or more other users of the social media platform;
identify one or more social media accounts followed by the social media account of the donor on the social media platform;
correlate a subject of the one or more social media accounts followed by the donor with one or more charities and with a topic of interest of the donor, wherein the one or more social media accounts are separate and distinct from a social media account of one of the charities, the one or more charities recommended based at least in part on the topic of interest of the donor;
identify text indicative of the topic of interest of the donor utilizing keyword search mechanisms on the social media data from the social media account of the donor;
generate a list of the one or more charities and, for each charity in the list, a recommended donation amount based at least in part on the financial health of the donor;
present, in a user interface of a web site served to the personal computing device or via an application running on the personal computing device, the list of the one or more charities and the recommended donation amount for each charity in the list;
retrieve, from one or more third party websites, data regarding donation opportunities for the one or more charities;
receive a global positioning system (GPS) coordinate from a location positioning sensor of the personal computing device of the donor;
determine, based on the GPS coordinate of the personal computing device, that the personal computing device is located within a predetermined distance from a charity in the list;
in response to determining from the GPS coordinate of the personal computing device that the personal computing device is within the predetermined distance from the charity in the list, provide, via the user interface, an alert of an opportunity to make a donation; and
generate, using the data from the one or more third party websites, a user selectable option displayable via the user interface that allows the donor to make the donation to the charity in the list presented via the user interface;
wherein a selection of the user selectable option provided by the user interface allows the donor to initiate the donation to the charity in the list.

18. (canceled)

19. The apparatus of claim 17, further comprising a charity vetting circuit structured to:
receive identity information from at least one of the one or more charities; and
validate at least one of the one or more charities.

20. (canceled)

21. (canceled)

22. The system of claim 1, wherein the financial history includes information related to at least one of: transaction executed by the donor, financial obligations of the donor, historical account balances, variability in expenses of the donor, and income of the donor.

23. (canceled)

24. The system of claim 1, wherein the user interface displayed by the application includes a plurality of user selectable options associated with each of the one or more charities recommended to the donor, wherein a selection of a user selectable option is configured to effectuate a donation by the donor to the associated charity.

25. The system of claim 8, wherein the bill pay user interface displayed by the application on the personal computing device of the donor is generated using data retrieved from at least one third party website.

26. The system of claim 25, wherein the bill pay user interface is configured to present a user interface with a same visual appearance as the user interface displayable on the personal computing device of the donor.

27. The method of claim 10, wherein the user interface includes a plurality of user selectable options for each of the one or more charities recommended to the donor, the selection from the donor of a charity being received in response to a selection by the donor of a user selectable option displayed by the application.

28. The method of claim 14 wherein the bill pay user interface displayed by the application on the personal computing device of the donor is generated using data retrieved from at least one third party website.

29. The method of claim 28, wherein the bill pay user interface is configured to present a user interface with a same visual appearance as the user interface displayable on the personal computing device of the donor.

30. The apparatus of claim 17, wherein the user interface includes a plurality of user selectable options associated with each of the one or more charities recommended to the donor, the selection of a selectable option being configured to effectuate a donation by the donor to the associated charity.

31. The apparatus of claim 30, wherein at least one user selectable option includes a bill pay option for paying a bill of one of the one or more charities recommended to the donor, the charity recommendation circuit displaying, by the application and on the personal computing device of the donor, a bill pay user interface in response to the selection by the donor of the bill pay option.

32. The apparatus of claim 31, wherein the bill pay user interface displayed by the application on the personal computing device of the donor is generated using data retrieved from at least one third party website.

33. The system of claim 32, wherein the bill pay user interface is configured to present a user interface with a same visual appearance as the user interface displayable on the personal computing device of the donor.
